(19) United States
(12) Patent Application Publication
(10) Pub. No.: US 2020/0007988 A1
(43) Pub. Date: Jan. 2, 2020

(54) WIRELESS SIGNAL SOURCE BASED AUDIO OUTPUT AND RELATED SYSTEMS, METHODS AND DEVICES

(71) Applicant: Microchip Technology Incorporated, Chandler, AZ (US)

(72) Inventor: Dinkar Raj, Muvattupuzha (IN)

(21) Appl. No.: 16/025,815

(22) Filed: Jul. 2, 2018

(51) Int. Cl. H04R 3/12; H04W 76/10; H04W 4/02

(52) U.S. Cl. CPC H04R 3/12; H04W 76/10; H04R 2430/01; H04R 2420/07; H04W 4/023

(57) ABSTRACT

Systems, methods and devices for audio output responsive to a wireless communication link are disclosed, as well as related systems, methods and devices. In various embodiments, a spatial position of a second device relative to a first device may be determined responsive to a wireless communication link between the first device and the second device, and, responsive to the determined spatial position, at least part of an audio signal may be processed to include audio effects, and speaker(s) that output sound corresponding to the processed audio signal may have a directional “feel” to a listener. Spatial position may include a spatial direction and/or a distance. In related systems, methods and devices, various actions may be taken responsive to spatial position of a first device relative to a second device, such as selecting audio content, loading audio content, requesting and/or receiving audio content from an audio content repository, changing audio effects that are encoded into audio content (e.g., adding, removing, updating, etc.), and combinations thereof.

### FIELD

The embodiments described herein relate, generally, to audio output and audio capture and, more specifically, some embodiments relate to audio content selection, audio output and audio capture related to a wireless communication link.

### BACKGROUND

Wireless communication typically involves the transmission and reception of radio frequency (RF) signals encoded with information between two transceivers that, at any given moment, may be either the transmitter or the receiver of the encoded signals. In order to promote interoperability, wireless communication typically follows rules (often called “protocols”) that define the syntax, semantics, synchronization, and error recovery of communication messages.

Audio streaming is one application of wireless communication. Generally, in audio streaming applications the encoded information in the wireless communication messages is audio information that may be used to generate audio at a speaker. The audio information may be an audio bitstream encoded using a form of pulse-coded modulation such as with the .wav format. The audio information may be uncompressed or compressed (e.g., according to .mp2, .mp3, AAC, etc.). There are many products and devices that incorporate audio streaming, including wireless headphones (in-ear and over-ear) and wireless speakers, as well as devices and products that incorporate such devices, such as mobile devices (e.g., smart phones and tablet computers), personal computers (e.g., workstations, desktops, laptops, etc.), and sound systems (e.g., systems of speakers used in movie theaters, concerts, automobiles, homes, intercom systems, headsets, etc.).

### BRIEF SUMMARY

Some embodiments of the disclosure relate, generally, to a method to output audio related to a wireless communication link. The method includes: wirelessly transmitting one or more communication messages between a sender and a receiver; adjusting at least one of a level and a timing of an audio signal responsive to a first spatial position of the sender, wherein the first spatial position of the sender is determined responsive to a first characteristic of at least one characteristic of a wireless communication link between the sender and receiver; and providing the adjusted audio signal to at least one audio sink.

Some embodiments of the disclosure relate, generally, to a method to output audio received over a wireless communication link. The method includes: establishing a wireless communication link between a sender and a receiver; receiving communication messages over the wireless communication link; and adjusting a level of an audio signal responsive to a first spatial direction of the sender and/or a distance between the receiver and the sender, wherein the first spatial direction of the sender and/or the distance between the receiver and the sender are determined, at least in part, responsive to at least one characteristic of the wireless communication link.

Some embodiment of the disclosure relate, generally, to a receiver. The receiver includes a transceiver, a communication controller, and an audio controller. The transceiver is configured to establish a wireless communication link. The communication controller is configured to determine a first spatial direction and a distance of a sender of one or more wireless communication messages over the wireless communication link. In one embodiment, the first spatial direction of the sender and the distance between the receiver and the sender are determined, at least in part, responsive to at least one characteristic of the wireless communication link. The audio controller is configured to adjust a timing of an audio signal responsive to a first spatial direction of the sender and/or a level of the audio signal responsive a distance between the receiver and the sender.

Some embodiments of the disclosure relate, generally, to a transmitter. The transmitter includes a transceiver and a controller. The transceiver is configured to establish at least a first wireless communication link. The controller is configured to: determine a first spatial position information of a receiver of one or more wireless communication messages over a first wireless communication link. In one embodiment, the first spatial position of the receiver is determined responsive to a first characteristic of at least one characteristic of the first wireless communication link. The controller is further configured to transmit the first spatial position over the first wireless communication link.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1A shows a block-diagram of a receiver according to an embodiment of the disclosure;

FIG. 1B shows a block-diagram of a sender according to an embodiment of the disclosure.

FIG. 1C shows an audio effects circuitry for a radio receiver of FIG. 1A, useable with directional audio applications, according to an embodiment of the disclosure;

FIG. 2 shows a process to output audio received over a wireless communication link, according to an embodiment of the disclosure;

FIG. 3 shows a headphone that includes an audio system-on-chip (SoC) having a receiver configured for sound direction and/or distance applications, according to an embodiment of the disclosure;

FIG. 4 shows a controller that is configured to select audio content to output or capture responsive to a spatial direction and/or distance of a sender, according to an embodiment of the disclosure;

FIG. 5 shows a flow chart of an audio content selection process for output or capture responsive to a spatial direction and/or distance of a sender, according to an embodiment of the disclosure;

FIG. 6 shows multiple audio sources simultaneously broadcasting audio streams to a headphone that is configured to use the spatial direction and/or distance of a sender to select among streamed audio content, according to an embodiment of the disclosure;

FIG. 7 shows an audio system that uses spatial direction and/or distance of a sender to control audio volume at a receiving device, according to an embodiment of the disclosure;

FIG. 8 shows controlling audio volume at a receiving device using the spatial direction and/or distance of a sender, according to an embodiment of the disclosure;

FIG. 9 shows a flowchart of a process of using spatial direction of a sender to control the gain of an audio signal, according to an embodiment of the disclosure.

FIG. 10 shows a diagram of an audio system that uses a virtual spatial direction of the sender during output of audio, according to an embodiment of the disclosure;

FIG. 11 shows an operation of a locator system, according to an embodiment of the disclosure;

FIGS. 12A and 12B show a locator system, according to an embodiment of the disclosure; and

FIG. 12C shows a locator system that uses directional sound, according to an embodiment of the disclosure.

### DETAILED DESCRIPTION

In the following detailed description, reference is made to the accompanying drawings, which form a part hereof, and in which are shown, by way of illustration, specific example embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure. The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

It will be readily understood that the components of the embodiments as generally described herein and illustrated in the drawings may be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

Thus, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It should be understood by a person of ordinary skill in the art that the signal may represent a bus of signals, wherein the bus may have a variety of bit widths and the disclosure may be implemented on any number of data signals including a single data signal.

It should be understood that any reference to an element herein using a designation such as “first,” “second,” and so forth does not limit the quantity or order of those elements, unless such limitation is explicitly stated. Rather, these designations are used herein as a convenient method of distinguishing between two or more elements or instances of an element. Thus, a reference to first and second elements does not mean that only two elements can be employed or that the first element must precede the second element in some manner. Also, unless stated otherwise a set of elements may comprise one or more elements. Likewise, sometimes elements referred to in the singular form may also include one or more instances of the element.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

Also, it is noted that the embodiments may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be re-arranged. A process may correspond to a method, a thread, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

As used in this disclosure, the terms “spatial direction of the sender” and “spatial direction of the source” mean, in the case of a transmitter and receiver that are wirelessly communicating, a direction from the receiver to the transmitter. Spatial direction of the sender may be represented in any suitable form, for example, using a known coordinate reference (e.g., north, south, east, and west) and expressed in terms of any suitable coordinate system, such as, for example, Cartesian coordinates or polar coordinates (which one of ordinary skill in the art would understand can both represent a same location in different forms). A spatial direction of the sender may also be represented with respect to a predefined reference point of the receiver. Using the example of a mobile device receiving a wireless message from a sending device, the mobile device may be defined as having a forward direction and the spatial direction of the sender may be represented in terms of an offset between the forward direction of the mobile device and the direction from the mobile device to the sending device. Thus, if the mobile device points toward (in terms of its forward direction) the sender then the offset would be 0°.

As used in this disclosure, “wireless communication link” means a physical communication channel between at least two devices (or available to be between at least two devices as in the case of a broadcaster and a listener) where the physical medium of communication is primarily radio-frequency (RF) waves. For example, a channel of a wireless communication link may be a frequency-specific communication path between the two devices. A channel may be part of a frequency spectrum allocated for communication that is comprised of many possible channels. A wireless communication link may actually use multiple channels within a frequency spectrum during communication between two devices, for example, using techniques such as frequency hopping and adaptive frequency hopping. A wireless communication link may be one-way (e.g., a one-way transmitter without equipment at the sending device to receive communication), and two-way (e.g., equipment to both send and receive). A wireless communication link may be, or be part of, a broadcast that may be received by many listeners. As used in this disclosure, “Communication message(s)” means the administrative messages (e.g., for setup of a wireless communication link) and the information messages (e.g., data payload) sent over a wireless communication link as one or more data packets.

This disclosure describes some radio transmitters and receivers as “transceivers,” which one of ordinary skill in the art would readily understand is as a device that may both transmit and receive communication messages. One of ordinary skill in the art would understand that a transceiver may be configured to be the equivalent of a receiver, a transmitter, or both. Moreover, it is specifically contemplated by this disclosure that, for some applications, a dedicated receiver or dedicated transmitter may be substituted for one or more of the transceivers of the embodiments described herein.

In some cases, the wireless transceiver that receives the wireless signal from another remote wireless transceiver may want to play/record audio associated with the remote transceiver. Unless specifically stated, it should be assumed that the audio may be transmitted over the same wireless communication link or may be transmitted over a different wireless communication link.

A spatial direction of a sender may be derived using any number of techniques. In one embodiment, the spatial direction of the sender may be determined based on a direction of propagation of an RF wave incident on a receiving antenna array. The receiving antenna array may use the differences in the time of arrival of waves incident the individual array elements of an antenna array to determine an orientation or offset relative to the receiving antenna array. In one embodiment, a receive signal strength indication (RSSI) measure may be calculated and used to determine a distance (i.e., spatial offset) between the transmitter and the receiver. Some embodiments may use Angle-of-Departure (AoD) and Angle-of-Arrival (AoA) to determine spatial direction and distance. In some cases, communication protocols may be configured to include information in packet headers that is useful for determining spatial direction, for example, Angle-of-Departure (AoD) and Angle-of-Arrival (AoA), so in some embodiments, the AoD and AoA do not need to be separately calculated. In another embodiment, a triangulation technique may be used to determine the spatial direction of the sender of a signal source.

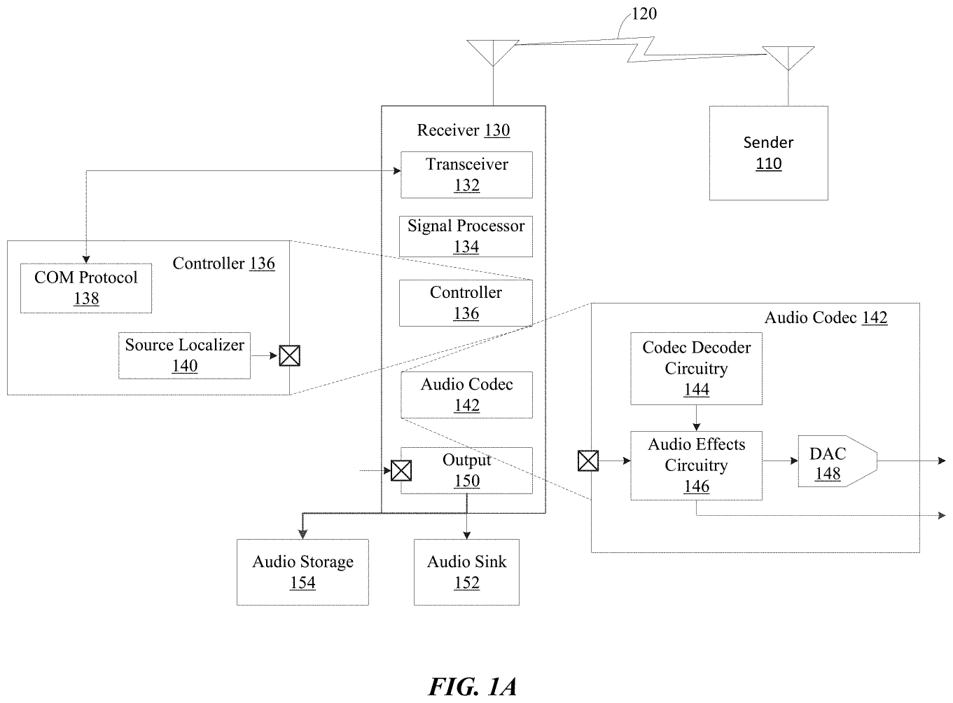

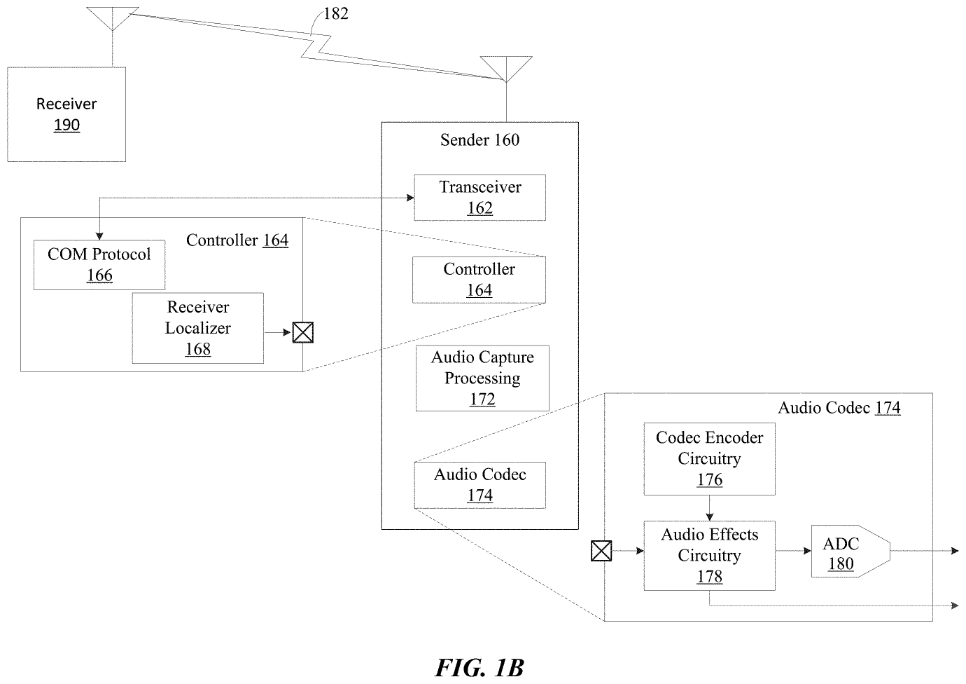

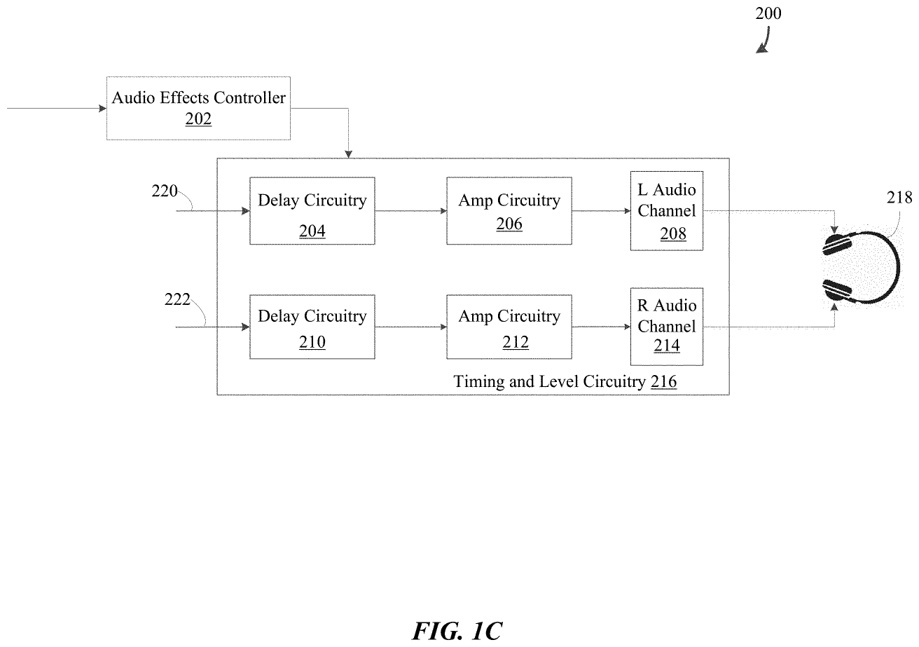

FIG. 1A shows a block-diagram of an audio system configured to output audio to an audio sink or an audio storage, responsive to a wireless communication link between a receiver and a sender, according to an embodiment of the disclosure. The sender 110 may be configured to send communication messages to the receiver 130 over or a wireless communication link 120. The communication messages may be data packets that include information that may be used to determine the spatial direction of the sender relative to the receiver 130. In one embodiment, the sender 110 may be a BLUETOOTH® beacon and the communication messages may be broadcast data packets that, among other things, include an identifier, packet type, an indication of transmission power, and more. In another embodiment, the data packets may include, among other things, identifiers for specific applications, RSSI, angle of transmission information, and more. In another embodiment, the sender 110 may send communication messages that are data packets having audio content, for example, streaming audio.

The receiver 130 may include a transceiver 132, a signal processor 134, a controller 136, an audio codec 142, and an output. The transceiver 132 may be a radio transceiver that is configured to communicate according to a protocol. The transceiver 132 may include an antenna array and be configured for wireless communication at one or more frequency bands, for example, 2.4 GHz, 3.6 GHz, 4.9 GHz, 5 GHz, and 5.9 GHz. In order to provide a general illustration, transceiver elements that would be typical for certain protocols are not shown, such as a modem, synthesizer, and/or a power manager.

The signal processor 134 may include one or more of decoders, filters, and samplers, and may be configured, generally, to perform digital audio processing such as noise cancellation or filtering audio more generally.

The audio codec 142 may include codec decoder circuitry 144, audio effects circuitry 146 and one or more digital-to-analog converts (DACs) 148. The audio codec 142 may be configured, generally, to decode an audio stream and output an analog audio signal. In one embodiment, the audio signal may correspond to audio content received from the sender. In one embodiment, the audio signal may be based on stored audio content, for example, that is stored at a memory accessible by the controller 136, or otherwise accessible by the audio codec 142. In yet another embodiment, the audio content may not be stored locally and may be received from a source other than the sender 110, for example, transmitted over another wireless communication link with the audio content source.

The codec decoder circuitry 144 may be configured to decode according to one or more codec formats, for example, SBC (low-complexity subband codec), AAC (advanced audio coding codec), MP3 (third-generation moving pictures experts group audio layer), or others. The audio effects circuitry 146 may be configured to add audio effects by amplifying, filtering or adding to the decoded audio signal. In one embodiment, the audio effects circuitry 146 may be configured to add audio effects responsive to a spatial direction and/or distance of the sender 110 and/or a virtual spatial direction and/or virtual distance. In one embodiment, the audio effects circuitry 146 may be configured to amplify the part of an audio signal that corresponds to one or more audio channels, while not amplifying other parts of an audio signal that correspond to different audio channels.

The DAC 148 may be configured to convert the audio signal having the audio effects to one or more analog signals, which may be provided to the output 150. The audio signal having the audio effects may also be output as a digital signal that is provided to the output 150. The output 150 may be configured to provide the analog and/or digital audio signals to an audio sink 152 and/or audio storage 154. In one embodiment, the output 150 may output the audio signal via one or more audio channels (e.g., left and right).

In one embodiment, the audio storage 154 may be a file or memory. In another embodiment, the audio storage 154 may be configured to provide at least some part of the audio signal having audio effects to a different receiver. For example, the receiver 130 may be incorporated into a wireless earbud that is paired with a second wireless earbud. The part of the audio signal corresponding to a left or right channel may be sent to the second wireless earbud, for example, using wireless communication.

The controller 136 may be, for example, microcontroller, a microprocessor and memory, digital logic, or a configurable state machine. A COM protocol 138 of the controller 136 may be configured to assist the transceiver 132 with executing one or more communication protocols, for example, to dynamically adjust the system to conserve power or to use more power to boost signal strength. A source localizer 140 may be configured to determine a spatial direction and/or distance of the sender associated with a wireless communication link. In one embodiment, the source localizer 140 may be configured to provide the spatial direction and/or distance of the sender to the audio codec 142, and the audio effects circuitry 146 may be configured to process a decoded audio signal responsive to the spatial direction and/or distance of the sender (for example, to add an audio direction to an audio signal).

In one embodiment, the source localizer 140 may use information encoded in wireless communication messages from the sender 110 or information that is part of a protocol to determine the spatial direction and/or distance of the sender 110. Some protocols may provide for information in a packet structure that can be used to determine spatial direction. Examples of information that may be included in the packet structure are transmit strength, RSSI, angle-of-departure (AoD) and angle of-arrival (AoA) in a packet structure, and in some embodiments the communication protocols (e.g., COM protocol 138) may provide AoD and AoA information associated with the communication messages sent by the sender 110 to the source localizer 140. In one embodiment, a sender 110 may send at least some spatial direction information using a higher layer protocol, and the source localizer 140 may determine spatial direction and/or distance responsive to spatial direction information sent using one or more of the higher layer protocol, the header information of a lower layer protocol, and/or locally determined information.

In one embodiment, the COM protocol 138 may be, or be part of, an application that is associated with the sender 110. Applications that are not associated with the sender 110 may be subject to restrictions on communicating with the sender 110, and, in one embodiment, may be unable to receive data packets sent by the sender 110. In addition, many of the functions of the transceiver 132, signal processor 134, and audio codec 142 may be performed by the controller 136 when these functions are embodied as software processes.

In some embodiments, the sender may determine the spatial direction of the receiver responsive to a wireless communication link with the receiver. In embodiments where the sender is configured for audio capture or to send stored audio content to the receiver more generally, then the sender may also encode captured audio to include audio effects responsive to the spatial direction of the receiver. The sender may store the captured audio content, store the spatial direction of a receiver, and/or store captured audio encoded responsive to the spatial direction of the receiver. The sender may also be configured to send spatial direction information to the receiver. In one embodiment, the sender may use aspects of a first protocol to determine the spatial direction information and then user another, higher level, protocol, to send this information.

When the spatial direction is determined at the sender, the source localizer at the receiver may be configured to determine the spatial direction of the sender responsive to spatial direction information received from the sender. In some embodiments, the receiver may not independently determine the spatial direction of the sender, and may use the spatial direction information from the sender to encode audio content, or, in embodiments where the audio content is already encoded, simply store or output the audio content.

FIG. 1B shows a sender 160 that is configured to capture audio and/or the spatial direction of a receiver 190. The sender 160 includes a transceiver 162, a controller 164, audio capture processing 172, and an audio codec 174. The controller 164 includes COM protocol 166 and receiver localizer 168. The COM protocol 166 is configured to enable control of the transceiver 162 according to any of a number of communication protocols. The receiver localizer 168 is configured to determine the spatial direction and/or distance of a receiver, such as the receiver 190 based on characteristics of a wireless communication link 182. By way of example, the receiver localizer 168 may be configured to use AoD, AoA, RSSI, transmit strength, and combinations thereof to determine spatial direction and/or distance.

In one embodiment, the receiver localizer 168 may be configured to store spatial direction information in terms of the spatial direction of the receiver 190 or the spatial direction of the sender 160 relative to the receiver 190.

Audio capture and processing 172 is configured to enable capture and/or processing of audio content. For example, the sender 160 may be operatively coupled to one or more microphones and audio capture and processing 172 may be configured to receive and process audio signals from the microphones. Audio capture and processing 172 may include one or more encoders, filters, and amplifiers for processing captured audio before it is stored as audio content. In some embodiments, audio capture and processing 172 may be configured to process capture audio according to one or more audio codecs, including audio codec 174. Audio codec 174 may include codec encoding circuitry 176, audio effects circuitry 178, and analog-to-digital converter (ADC) 180. The codec encoding circuitry 176 may be configured to encode audio according to any of a number of formats. The audio effects circuitry 178 may be configured to add audio effects—e.g., timing, level, etc.—to audio, including responsive to spatial direction information.

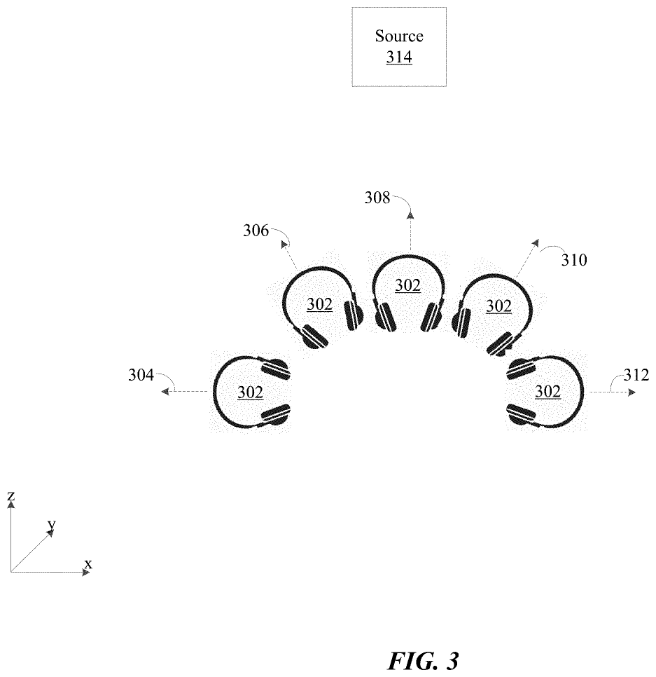

FIG. 1C shows an embodiment of audio effects circuitry 200 at a receiver (such as receiver 130 of FIG. 1A) and/or a sender (such as sender 160 of FIG. 1B) useable with directional audio applications. To a user of headphones 218 configured for directional audio direction applications, the audio from the left and right speakers will sound like it is coming from the direction of an audio sender, referred to herein as having a “sound direction.” An example of sound direction is shown in FIG. 3. The audio effects circuitry 200, may include an audio effects controller 202 that is operatively coupled to timing and level circuitry 216. Timing and level circuitry 216 may be configured to process left audio signal 220 and right audio signal 222 by delaying and/or amplifying parts of the audio signals by delay circuitry 204, 210 and amp circuitry 206, 212 for a left audio channel 208 and a right audio channel 214, respectively. The differences in level and timing between the sound output at left and right speakers of headphones result in a sound direction effect due to the way the human brain processes sound (e.g., the sound pressure waves).

The audio effects controller 202 may be configured to set or configure timing and level circuitry 216 responsive to the spatial direction and/or distance of the sender 110 associated with, e.g., the wireless communication link 120 (FIG. 1A) or wireless communication link 182 (FIG. 1B). In one embodiment, the audio effects controller 202 may be, or may include, a panning controller.

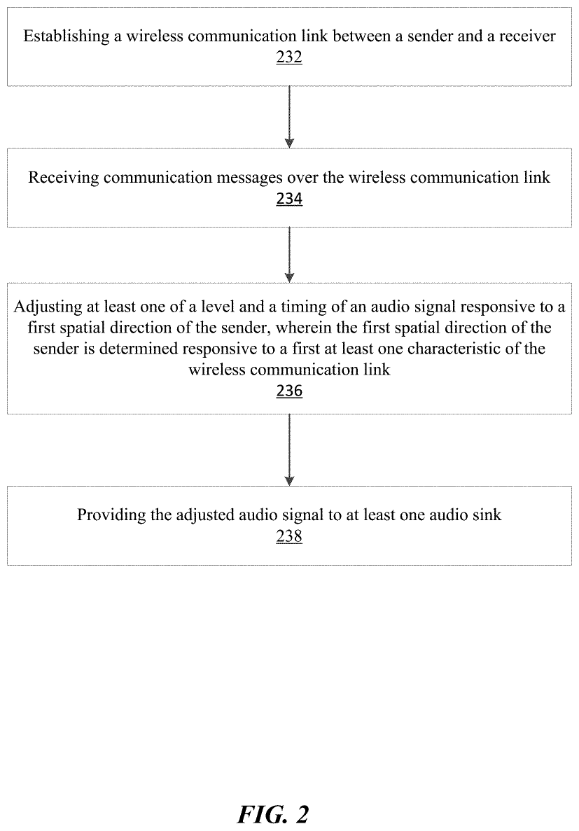

FIG. 2 shows a process to output audio received over a wireless communication link, according to an embodiment of the disclosure. In operation 232, a wireless communication link is established between a sender and a receiver. In operation 234, communication messages are received over the wireless communication link. In one embodiment, the communication messages may include audio content. In another embodiment, the communication messages may be advertisements or low level communication messages. In operation 236, at least one of a level and a timing of an audio signal corresponding to the audio stream is adjusted responsive to a first spatial direction of the sender. In one embodiment, the first spatial direction of the sender is determined responsive to a first characteristic of at least one characteristic of the wireless communication link. In operation 238, the adjusted audio signal is provided to at least one audio sink.

FIG. 3 shows a headphone 302 that includes an audio system-on-chip (SoC) having a receiver 130 (FIG. 1A) configured for sound direction applications, according to an embodiment of the disclosure. A headphone 302 has a wireless communication link with a source 314. As the headphone 302 changes orientation, the timing and level of the audio signals provided to the left and right speakers are adjusted to provide different directional sound. At position 304, the sound comes almost entirely from the right speaker. At position 306, the sound comes out of the right and left speaker, but the timing of the audio signal at the right speaker is slightly ahead of the audio signal at the left speaker and the level is greater. At position 308, the sound comes from both the right and the left speaker, and the timing and level of the audio signals are about the same. At position 310, the sound comes out of the right and left speaker, but the timing of the audio signal at the left speaker is slightly ahead of the audio signal at the right speaker and the level is greater. At position 312, the sound come almost entirely from the left speaker. When used, the sound from speakers of the headphone 302 feels (spatially) to a listener as if it comes from the direction of the source 314, that is, whether the listener is oriented toward 304, 306, 308, 310, or 312, in all cases, a listener may perceive the sound to come from the direction of source 314.

The rendering sink arrangement is not limited to just left and right channels, and may include any number of channels that facilitate directional sound, for example, 5.1 surround sound (i.e., six channels), 7.1 surround sound (i.e., eight channels), and full-sphere surround sound techniques (e.g., ambisonics).

In various embodiments described herein, the timing and level of the left and right audio signals are processed in an audio codec that is incorporated into a radio receiver, however, the disclosure is not limited to this arrangement. It is specifically contemplated that the timing and level may be processed in software or firmware of a system outside the receiver, such as an audio SoC.

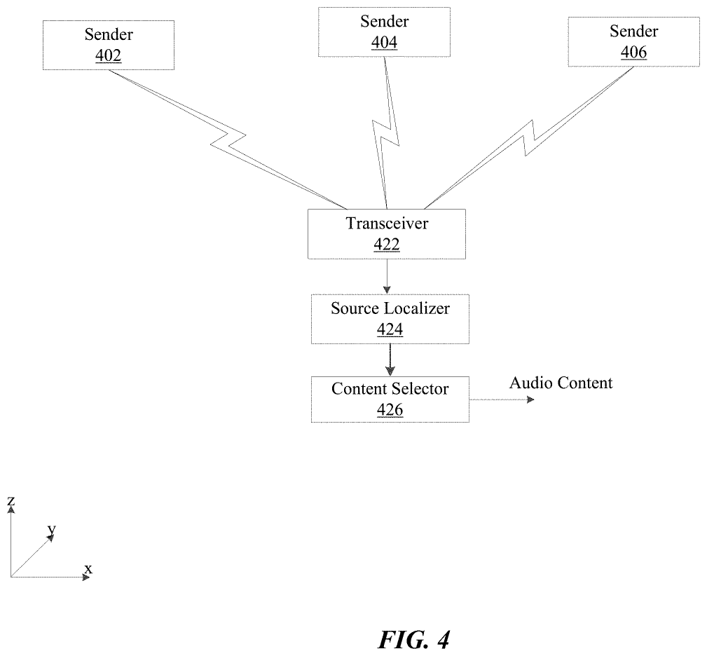

Embodiments for selecting audio content responsive to the spatial direction of one or more senders responsive to a wireless communication link will now be described with reference to FIGS. 4, 5, and 6. FIG. 4 shows an audio content selector 426 that is configured to select audio content responsive to a spatial direction of a sender 402, 404, and 406, received from the source localizer 424. The source localizer 424 may be configured to determine the spatial direction of the senders responsive to communication messages received over one or more wireless communication links with the senders 402, 404, and 406. In one embodiment, the audio content is locally stored. In another embodiment, the audio content is stored remotely and is requested responsive to the audio content selected by the content selector 426.

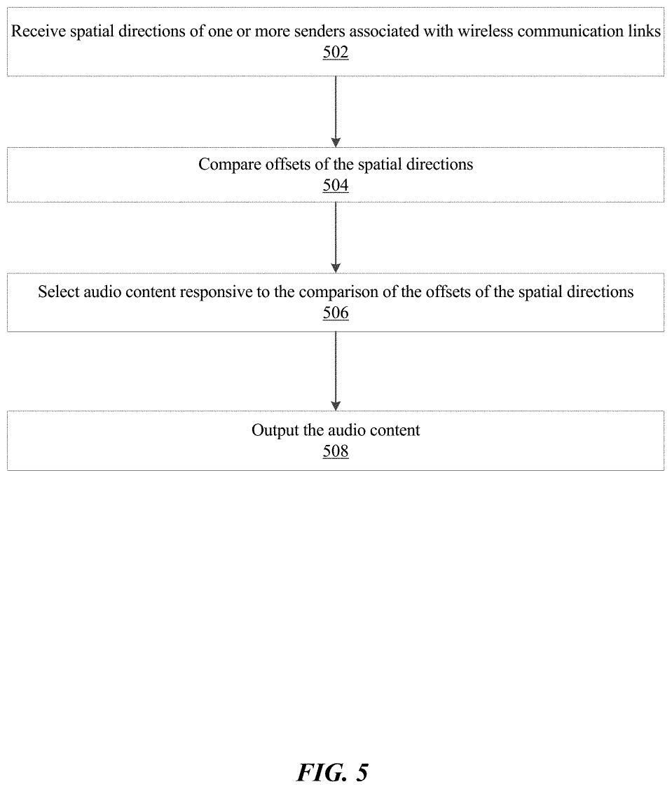

FIG. 5 shows a flow chart of an audio content selection process that may be implemented, for example, by a content selector 426, according to an embodiment of the disclosure. In operation 502, the spatial direction of senders are received for a group of senders of communication messages that are associated with wireless communication links. In one embodiment, each spatial direction may be provided with a sender identifier. The sender identifiers may be based on identifiers decoded from communication messages. In operation 504, offsets of the spatial directions are compared. In one embodiment, the spatial directions may be represented as an offset from a reference direction (e.g., forward), and in another embodiment, an offset from a reference direction may be calculated. In operation 506, audio content is selected responsive to the comparison of the offsets of the spatial directions of the senders. In one embodiment, the spatial direction of the sender that is selected has the smallest offset from a reference direction of a receiver. In one embodiment, the audio content may be indexed according to sender identifiers, so, when a sender identifier is selected responsive to the offset comparison then it may be used to select the corresponding audio content in the index. The audio content may be stored locally, and it may be stored remotely. If stored remotely, an audio content request may be generated and sent to the manager of the audio content, and the audio content request may include the sender identifier or a value indicative of the sender value. In operation 508, the selected audio content is output.

In one embodiment, even if an offset is the smallest of the group senders, in some embodiments, the offset is compared to a threshold. In one embodiment, the threshold may be application dependent, for example, even though a receiving device faces toward one audio source more so than the other audio sources, all of the audio sources may be behind a user and so for some applications the process may not enable or select any audio source.

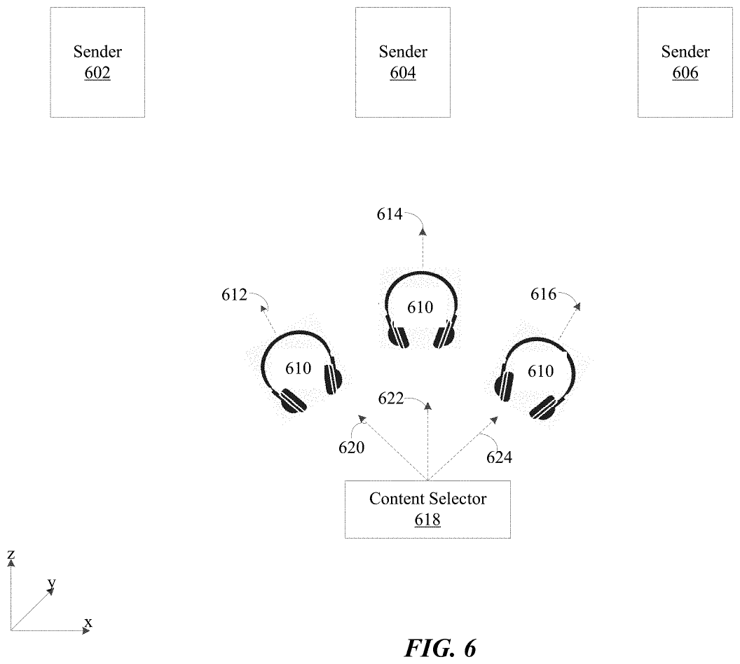

FIG. 6 shows an example where there are multiple senders 602, 604, and 606 all simultaneously broadcasting wireless communication messages to the headphones 610. At orientation 612, the content selector 618 selects the audio content 620 associated with sender 602, and the headphone 610 plays the audio content 620. At orientation 614, the audio content 622 associated with sender 604 is selected, and the headphone 610 plays the audio content 622. At orientation 616, the audio content 624 associated with sender 606 is selected, and the headphone 610 plays the audio content 624. In one embodiment, as the headphone 610 changes orientation from 612 to 614 and then to 616, the selection logic of the content selector 618 is configured to perform the audio content selection process continuously, and effectuate a change to play new audio content responsive to a new sender having the smallest offset.

In one embodiment, the sender may be configured to determine the spatial direction of the receiver. When the sender determines that the receiver is oriented toward the sender responsive to the spatial direction of the receiver, the receiver then sends audio content to the receiver, in one case, using a higher layer communication protocol to stream the audio content.

One of ordinary skill in the art would appreciate that the embodiments shown in FIGS. 4, 5 and 6 have many applications. For example, in a museum with many exhibits in a large room, a sender associated with a wireless communication link may be associated with each exhibit and broadcast communication messages associated with the exhibit. When a user wearing headphones that discriminate among the communication links based on relative position of associated senders faces an interesting exhibit, the headphones then could play the audio for that exhibit until the user faced away from the exhibit. The audio for the exhibit may be included in the communication messages or it may be recorded and saved at the user's headphone. In one embodiment, the audio may be streamed separately from the communication link, for example, by remote server (e.g., over WiFi). In this example, the headphone may request the audio from the server based on an identifier provided by the sender. If the user faced a second exhibit, the headphones could then change based on the spatial direction of the sender of the second exhibit versus the first exhibit. Conventional audio systems typically do not have the ability to discriminate among wireless communication links and to a fine enough degree or a user has to manually select a channel associated with the sender. Notably, in embodiments of the disclosure, at least some of the senders 402, 404 and 406 may use the same wireless communication channel without using an identifier associated with the sender.

Another application for directional sound based on the spatial direction of the sender is a headphone designed to assist visually impaired persons by providing audio cues. Multiple audio source may be provided that broadcast communication messages about the environment of the user. By using directional sound, the user may feel the direction of the audio as well as aspects of his or her environment. For example, a user that is walking down a long hall may receive an audio cue indicative whether the user is walking straight down the hall. If the user begins to wander from a straight path, the audio cues change based on the change in the spatial direction of the sender of the audio source, which changes the directional sound the user hears. The change in directional sound may prompt a user to change the direction they are walking.

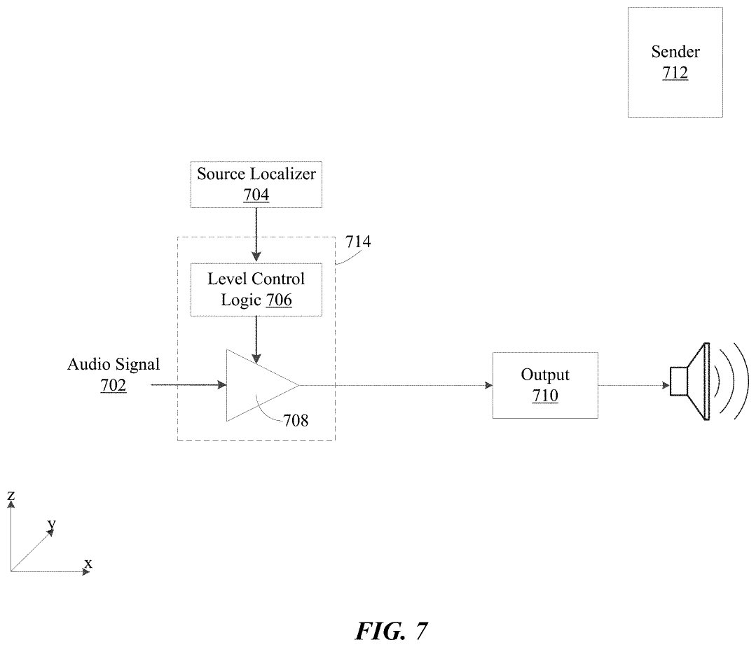

FIG. 7 shows an audio system that uses spatial direction of the sender to control the audio volume at a receiving device, according to an embodiment of the disclosure. For some applications, the additional processing required for directional sound may be unnecessary, too power hungry, or have other constraints. An audio effects circuitry 714 may include level control logic 706 and gain 708. The source localizer 704 provides the spatial direction of the audio sender 712 to level control logic 706, and the level control logic 706 uses the spatial direction of the audio sender 712 to adjust a gain 708 on the level of the audio signal 702. In one embodiment, level control logic 706 is configured to adjust up or down a gain 708 on the level of the audio signal responsive to the spatial direction of the audio sender 712. In one embodiment, the audio effects circuitry 714 may be incorporated into audio codec, such as audio codec 142, and in another embodiment it may be performed in the software of an associated system.

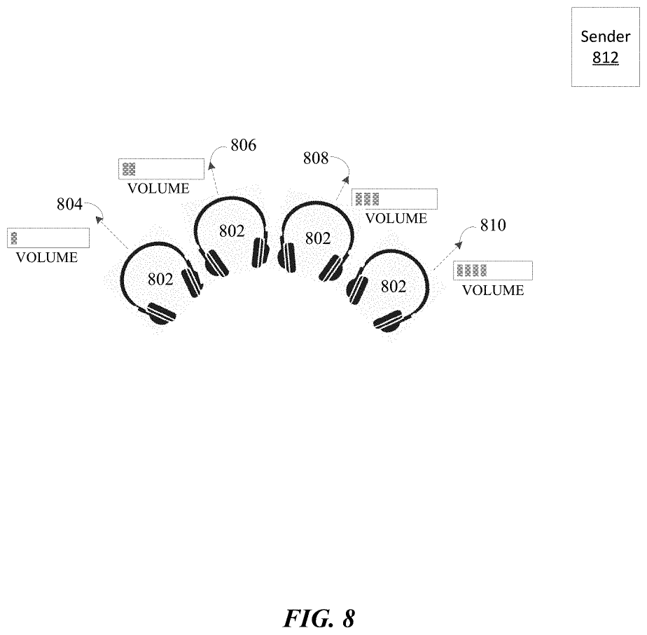

FIG. 8 shows an example of using the spatial direction of the sender to control to volume of sound, according to an embodiment of the disclosure. As the orientation of headphone 802 progressively changes to face audio sender 812, the volume of the audio at the headphone 802 increases progressively for each of orientations 804, 806, 808, and 810.

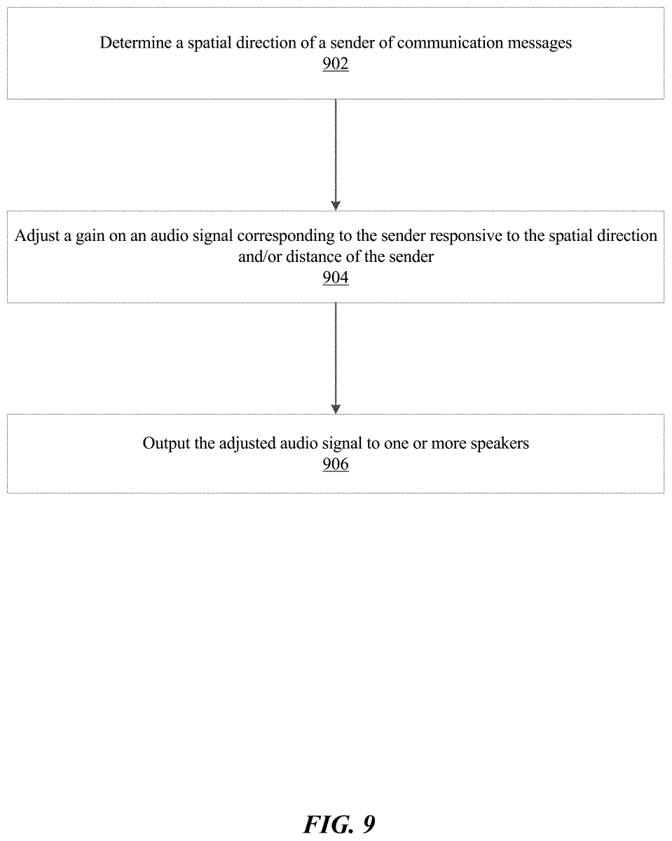

FIG. 9 shows a flowchart of a process of using spatial direction of a sender to control the gain of an audio signal. In operation 902, a spatial direction of a sender associated with a wireless communication link is determined. In operation 904, the gain on an audio signal corresponding to the wireless communication link is adjusted responsive to the spatial direction of the sender. In one embodiment, the gain on the audio signal may be adjusted according to an offset between a current direction of the receiving device and the spatial direction of the sender (e.g., ±5°, ±10°, ±20°, etc.). As the offset increases or decreases the gain may continuously or periodically increase or decrease proportionally. In operation 906, the adjusted audio signal is output to one or more speakers.

In some embodiments, a virtual spatial direction of the sender may be used. A virtual spatial direction of a sender may be the actual spatial direction of the sender of the audio source, as determined by the audio source, for example, during a communications link setup process. In another embodiment, the virtual spatial direction of the sender may be different than the actual spatial direction of the sender of the audio source. In one embodiment, the virtual spatial direction of the sender may be selected to provide virtual sound direction.

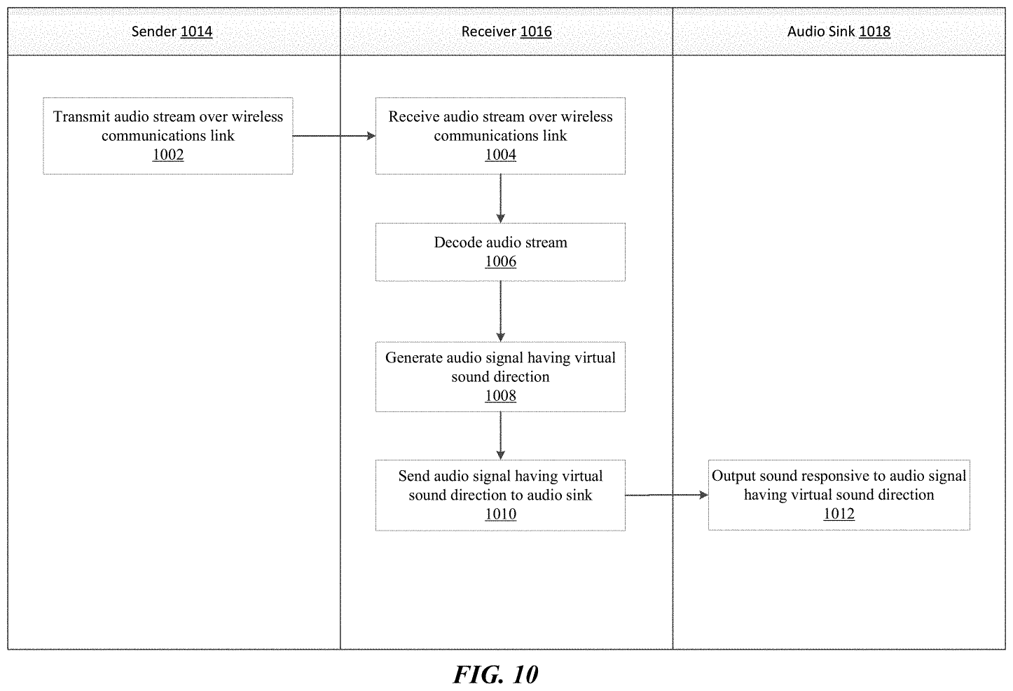

FIG. 10 shows a diagram where a receiver 1016 is configured to determine and use a spatial direction of a sender 1014 where the sender 1014 sends a virtual spatial direction of the sender with audio. In operation 1002, sender 1014 transmits communication messages and a virtual spatial direction and/or virtual distance of the sender to a receiver over a wireless communication link. In one embodiment the communication messages include audio data, in another embodiment, the audio data is a file at the receiver. In one embodiment, the virtual spatial direction of the sender may be an AoA and/or AoD. In operation 1004, the receiver receives the communication messages and the virtual spatial direction of the sender over the wireless communication link. In operation 1006, the receiver 1016 decodes the audio associated with the sender and/or the wireless communication link. In operation 1008, the receiver 1016 encodes an audio signal (for example, adjusting timing and level according to techniques described above), having virtual sound direction responsive to a virtual spatial direction and/or virtual distance of the sender received from the sender 1014. In operation 1010, the receiver sends the audio signal having virtual sound direction to the audio sink. In operation 1012, the audio sink outputs sound responsive to the audio signal having virtual sound direction.

In one embodiment, multiple virtual spatial directions of the sender may be provided with an audio stream. Each virtual spatial direction may be associated with a different part of the audio stream (and the corresponding audio signal) in the time domain. Thus, when a user listens to the output audio, virtual sound direction may feel like it comes from different directions at different time segments. In another embodiment, multiple virtual spatial directions of the sender may be provided and associated with time segments of an audio file.

In one embodiment, the virtual spatial direction of the sender may be incorporated into the system for the visually impaired as described above. Virtual spatial direction of the senders may be provided by a monitoring system to provide a user additional directional sound prompts. For example, even if a user changes the direction they are walking, additional adjustment (e.g., move more to the side of the hallway) may be warranted for safety reasons. Virtual spatial direction of the senders may be used to prompt the user to make the additional adjustments.

In one embodiment, a virtual spatial direction of the sender may be used if the original audio was a binaural recording and then converted into a mono audio file with one or more virtual spatial direction of the senders. In various embodiments, the virtual spatial direction of the senders may be used to recover the stereo audio effects of the binaural recording. When the recording is played, it may include virtual directional sound.

Embodiments of the disclosure may also be directed to a locator system. A locator system may use the spatial direction of the sender of a transmitting device determined at a receiver module to provide one or more indicators (e.g., visual, audio, etc.) that change as the relative spatial direction of the sender changes. In one embodiment, the changes in indicators may be indicative of whether the receiver is moving closer to, or father away from, a transmitting device.

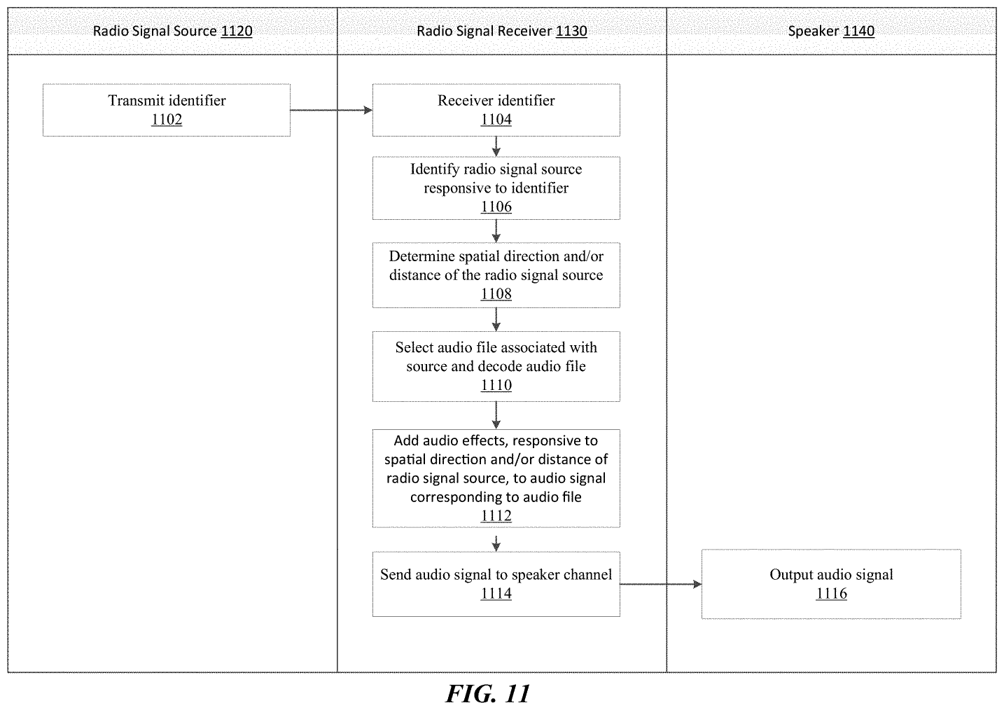

FIG. 11 shows an operation of a locator system, according to an embodiment of the disclosure. In operation 1102, a radio signal source 1120 transmits an identifier. In one embodiment, the radio signal source 1120 may broadcast a unique identifier to nearby devices, for example, as a beacon. In operation 1104, the radio signal receiver 1130 receives the transmitted identifier. In one embodiment, an application or an operation system associated with the radio signal source 1120 that is executing at the radio signal receiver 1130 may identify the radio signal source 1120, responsive to the identifier, as a known device or a device that is participating in a service. In operation 1108, the radio signal receiver 1130 determines the spatial direction of the radio signal source 1120. In one embodiment, the radio signal receiver 1130 determines the spatial direction of the radio signal source 1120 based on or more characteristics of a wireless communication link between the radio signal source 1120 and the radio signal receiver 1130. In operation 1110, the radio signal receiver 1130 selects an audio content associated with radio signal source 1120 responsive to the identifier, and decodes the audio content. In one embodiment, the audio content may be associated with a mobile application that is configured to participate in a locator service of which the radio signal source 1120 is part.

In operation 1112, the radio signal receiver 1130 adds audio effects, responsive to the spatial direction of the radio signal source 1120, to an audio signal corresponding to the selected audio content. In operation 1114, the radio signal receiver 1130 sends an audio signal that includes the audio effects to a speaker channel. In operation 1116, the speaker 1140 outputs sound corresponding to the audio signal having the audio effects. In one embodiment, the audio effects are configured to cause sounds to feel like it is coming from the direction of the radio signal source 1120.

In some embodiments, the selected audio content is one of a number of audio files that are stored at the radio signal receiver 1130. The radio signal receiver 1130 may be a mobile phone or other mobile device with a memory, processor, and a modem. The audio files may be associated with identifiers or services. For example, each audio file may correspond to a unique sound, and each audio file may be associated with a different unique identifier of a number of radio signal sources. When an audio file is played, the hearer may associate the sound with a different radio signal source. In embodiments where the radio signal source is affixed to a device (e.g., a BLE tag affixed to car keys, medication container, a computer tablet, clothing, etc.) then the hearer may associate the unique sound with a specific device to which the radio signal source is affixed.

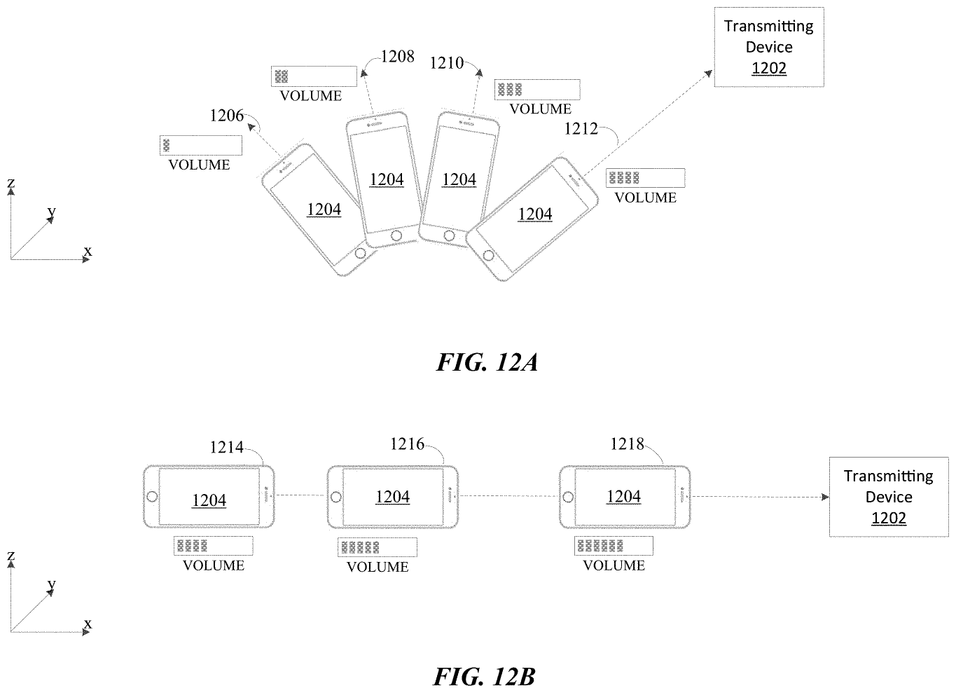

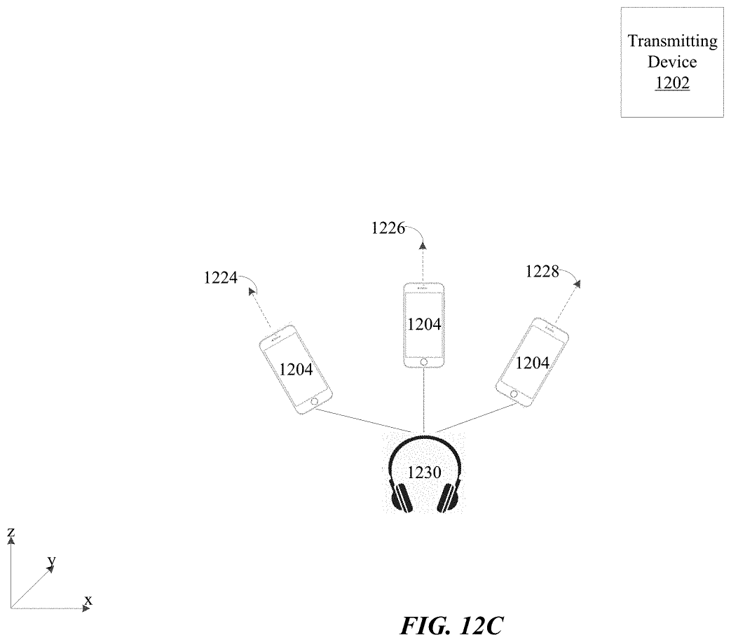

FIGS. 12A, 12B, and 12C show a locator system according to an embodiment of the disclosure. The locator system includes a transmitting device 1202 that has a wireless communications link with a mobile device 1204. The mobile device may include a receiver having audio effects circuitry, such as the audio effects circuitry 714 shown in FIG. 7, that is configured to determine the spatial direction of the transmitting device 1202, and provide the spatial direction of the transmitting device 1202 to an application executing at the mobile device 1204. The application may be configured to control the display, speaker, actuator, other indicator sub-systems, and combinations thereof of a mobile device 1204 responsive to changes in the spatial direction of the transmitting device 1202. In one embodiment, the mobile device 1204 may be configured to control the indication sub-systems similar to the embodiments described with reference to FIGS. 8 and 9.

For example, as shown in FIG. 12A, as the orientation of mobile device 1204 changes so that it faces the transmitting device 1202, the volume of an audible indicator increases responsive to the change in spatial direction of the sender at orientations 1206, 1208, 1210, and 1212 In some embodiments, additional audio, haptic, and visual indicators may be provided, for example, changes to a frequency of a vibration, blinking light and/or beeping sounds.

FIG. 12B shows that based on a change in distance between the mobile device 1204 and transmitting device 1202, the volume increases. So, as the mobile device 1204 moves progressively closer to the transmitting device 1202 at positions 1214, 1216, and 1218, the volume increases. Again in some embodiments, additional audio and visual indicators may be provided, such as, for example, changes to a frequency of a blinking light and/or a beeping sound. In one embodiment, distance may be determined using RSSI information, and an indicator may be controlled responsive to an RSSI. For example, a loud sound may correspond to a higher RSSI than the RSSI of a quieter sound.

In one embodiment the transmitting device 1202 may be a beacon affixed to something else, for example, a keychain, another mobile device, an article of clothing, etc. In one embodiment, the transmitting device 1202 may be a device without an independent power source (such as a battery), and transmission by the transmitting device 1202 may be powered by a carrier wave transmitted by the mobile device 1204. For example, the transmitting device 1202 may operate according to near-field communication (NFC) or radio-frequency identification (RFID).

FIG. 12C shows a locator system according to another embodiment of the disclosure. The locator system includes a transmitting device 1202, a mobile device 1204 and a pair of headphones 1230. In position 1224, the sound feels as if it comes from the right of user. In position 1226, the sound feels as if it comes from a little bit in front and a little bit to the right of the user. In position 1228, the sound feels as if it comes from substantially in front of the user. As a user changes the orientation of the mobile device 1204 toward the transmitting device 1202, the sound feels as if the user is turning toward the direction of the transmitting device 1202.

Examples of frequency spectrums allocated for commercial communication services include very low frequency (3 kHz-30 kHz), low frequency (30-300 kHz), medium frequency (300 kHz-3,000 kHz), and high frequency (3 MHz-30 MHz), very high frequency (30 MHz-300 MHz), ultra-high frequency (300 MHz-3000 MHz), super high frequency (3 GHz-30 GHz), and extremely high frequency (30 GHz-300 GHz). 2.4 Ghz, 3.5 GHz, and 5 GHz are unlicensed frequencies generally available for communication, including by wireless routers and BLUETOOTH® devices.

Many of the functional units described in this specification may be described as modules, threads, or other segregations of programming code, in order to more particularly emphasize their implementation independence. Modules may be at least partially implemented in hardware, in one form or another. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable state machines, programmable logic devices, or the like.

Modules may also be implemented using software, stored on a physical storage device (e.g., a computer-readable storage medium), in memory, or a combination thereof for execution by various types of processors.

An identified module of executable code may, for instance, comprise one or more physical or logical blocks of computer instructions, which may, for instance, be organized as a thread, object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several storage or memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices, which are referred to herein as computer-readable media.

In some embodiments, the software portions are stored in a non-transitory state such that the software portions, or representations thereof, persist in the same physical location for a period of time. Additionally, in some embodiments, the software portions are stored on one or more non-transitory storage devices, which include hardware elements capable of storing non-transitory states and/or signals representative of the software portions, even though other portions of the non-transitory storage devices may be capable of altering and/or transmitting the signals. One example of a non-transitory storage device includes a read-only memory (ROM), which may store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

While certain illustrative embodiments have been described in connection with the figures, those of ordinary skill in the art will recognize and appreciate that the scope of this disclosure is not limited to those embodiments explicitly shown and described in this disclosure. Rather, many additions, deletions, and modifications to the embodiments described in this disclosure may be made to produce embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

Additional non-limiting embodiments of the present disclosure include:

### Embodiment 1

A method to output audio related to a wireless communication link, comprising: wirelessly transmitting one or more communication messages between a sender and a receiver; adjusting at least one of a level and a timing of an audio signal responsive to a first spatial position of the sender, wherein the first spatial position of the sender is determined responsive to a first characteristic of at least one characteristic of a wireless communication link between the sender and receiver; and providing the adjusted audio signal to at least one audio sink.

### Embodiment 2

The method of Embodiment 1, wherein the spatial position comprises one or more of spatial direction and distance.

### Embodiment 3

The method of any of Embodiments 1 or 2, wherein the sender is configured to determine the first spatial position of the sender.

### Embodiment 4

The method of any of Embodiments 1 to 3, wherein the sender is configured to determine the first spatial position of the receiver.

### Embodiment 5

The method of any of Embodiments 1 to 4, wherein the receiver is configured to determine the first spatial position of the sender.

### Embodiment 6

The method of any of Embodiments 1 to 5, wherein the at least one characteristic of the wireless communication link is selected from a group consisting of a signal strength, an angle-of-departure, an angle of-arrival, time of arrival of waves incident individual array elements of an antenna array, triangulation and combinations thereof of a radio frequency wave corresponding to the wireless communication link.

### Embodiment 7

The method of any of Embodiments 1 to 6, further comprising adjusting at least one of a level and a timing of a second audio signal responsive to a second spatial position of the sender, wherein the second spatial position of the sender is determined responsive to a second characteristic of the at least one characteristic of the wireless communication link.

### Embodiment 8

The method of any of Embodiments 1 to 7, wherein the first spatial position of the sender and the second spatial position of the sender are different.

### Embodiment 9

The method of any of Embodiments 1 to 8, wherein the adjusting the at least one of a level and a timing of the audio signal comprises adjusting the timing and the level of at least one of a first part of the audio signal or a second part of the audio signal, wherein the first part of the audio signal corresponds to a first output channel of the at least one audio sink and the second part of the audio signal corresponds to a second output channel of the at least one audio sink.

### Embodiment 10

The method of any of Embodiments 1 to 9, wherein the first output channel and the second output channel are associated with a multichannel output, and the multichannel output comprises two or more channels.

### Embodiment 11

The method of any of Embodiments 1 to 10, further comprising: outputting the first audio part of the audio signal at a first speaker by way of the first output channel; and outputting the second audio part of the audio signal at a second speaker by way of the second output channel.

### Embodiment 12

The method of any of Embodiments 1 to 11, wherein the first speaker and the second speaker are incorporated into one or more devices selected from a group consisting of a stereo speakers, headphones, earbuds, hearing aids, bone conduction devices, and combinations thereof.

### Embodiment 13

A receiver, comprising: a transceiver configured to establish at least one wireless communication link; a controller configured to determine a first spatial position of a sender of one or more wireless communication messages over the at least one wireless communication link, wherein the first spatial position of the sender is determined responsive to a first characteristic of at least one characteristic of the at least one wireless communication link; and an audio codec comprising decoder circuitry and audio effects circuitry, wherein the audio codec is configured to process audio data into an audio signal by: decoding the audio data; and adjust at least one of a timing and a level of an audio signal corresponding to the decoded audio data responsive to the first spatial position of the sender.

### Embodiment 14

The receiver of any of Embodiments 1 to 13, wherein the spatial position comprises one or more of spatial direction and distance.

### Embodiment 15

The receiver of any of Embodiments 1 to 14, wherein the at least one characteristic of the at least one wireless communication link is selected from a group consisting of a signal strength, an angle of angle-of-departure, an angle of-arrival, triangulation, and combinations thereof of a radio frequency wave corresponding to the at least one wireless communication link.

### Embodiment 16

The receiver of any of Embodiments 1 to 15, wherein the audio codec is further configured to adjust at least one of a level and a timing of a second audio signal responsive to a second spatial position of the sender, wherein the second spatial position of the sender is determined responsive to a second characteristic of the at least one characteristic of the at least one wireless communication link.

### Embodiment 17

The receiver of any of Embodiments 1 to 16, wherein the first spatial position and the sender and the second spatial position of the sender are different.

### Embodiment 18

The receiver of any of Embodiments 1 to 17, wherein the audio effects circuitry comprises: a delay circuitry configured to adjust a timing of at least one of a first part of the audio signal or a second part of the audio signal; an amplifier circuit configured to adjust a level of at least one of the first part of the audio signal or the second part of the audio signal; and wherein the first part of the audio signal corresponds to a first output channel of an audio sink and the second part of the audio signal corresponds to a second output channel of the audio sink.

### Embodiment 19

A method to output audio received over a wireless communication link, comprising: establishing a wireless communication link between a sender and a receiver; receiving communication messages over the wireless communication link; and adjusting a level of an audio signal responsive to a first spatial direction of the sender and/or a distance between the receiver and the sender, wherein the first spatial direction of the sender and/or the distance between the receiver and the sender are determined, at least in part, responsive to at least one characteristic of the wireless communication link.

### Embodiment 20

The method of Embodiment 19, wherein the first spatial position comprises one or more of spatial direction and distance.

### Embodiment 21

The method of any of Embodiments 19 or 20, wherein the adjusting the level of the audio signal responsive to the distance between the receiver and the sender comprises increasing the level of the audio signal responsive to an increase in the first spatial position of the sender.

### Embodiment 22

The method of any of Embodiments 19 to 21, wherein the adjusting the level of the audio signal responsive to the distance between the receiver and the sender comprises decreasing the level of the audio signal responsive to an decrease in the first spatial direction and/or distance of the sender.

### Embodiment 23

The method of any of Embodiments 19 to 22, wherein the at least one characteristic of the wireless communication link comprises one or more of a signal strength, an angle of angle-of-departure, an angle-of-arrival, triangulation and combinations thereof of a radio frequency wave corresponding to the wireless communication link.

### Embodiment 24

The method of any of Embodiments 19 to 23, wherein adjusting the level of the audio signal responsive to the distance between the receiver and the sender comprises increasing the level of the audio signal responsive to a decrease in the distance between the receiver and the sender.

### Embodiment 25

The method of any of Embodiments 19 to 24, wherein adjusting the level of the audio signal responsive to the distance between the receiver and the sender comprises decreasing the level of the audio signal responsive to an increase in the distance between the receiver and the sender.

### Embodiment 26

A receiver, comprising: a transceiver configured to establish a wireless communication link; a communication controller configured to determine a first spatial direction and a distance of a sender of one or more wireless communication messages over the wireless communication link, wherein the first spatial direction of the sender and the distance between the receiver and the sender are determined, at least in part, responsive to at least one characteristic of the wireless communication link; and an audio controller configured to adjust a timing of an audio signal responsive to a first spatial direction of the sender and/or a level of the audio signal responsive a distance between the receiver and the sender.

### Embodiment 27

A transmitter, comprising: a transceiver configured to establish at least a first wireless communication link; a controller configured to: determine a first spatial position information of a receiver of one or more wireless communication messages over a first wireless communication link, wherein the first spatial position of the receiver is determined responsive to a first characteristic of at least one characteristic of the first wireless communication link; and transmit the first spatial position over the first wireless communication link.

### Embodiment 28

The transmitter of Embodiment 27, further comprising: audio capture circuitry configured to receive audio signals indicative of audio pressure waves; an audio codec comprising encoder circuitry and audio effects circuitry, wherein the audio codec is configured to process the audio data signals into audio data by: encoding the audio data responsive to the audio signals; and adjust at least one of a timing and a level of the audio signal or encoded audio data responsive to the first spatial position of a sender.

### Embodiment 29

The transmitter of any of Embodiments 27 or 28, wherein the transceiver is configured to establish a second wireless communication link, and the controller is configured to: transmit communication messages over the first wireless communication link responsive to a first protocol; and transmit communication messages of the second wireless communication link responsive to a second protocol, wherein the second protocol is a higher layer protocol than the first protocol.

1. A method, comprising:
wirelessly transmitting one or more communication messages between a sender and a receiver;
receiving a first communication message of the one or more communication messages the first communication message including information about a first characteristic of a first radio frequency (RF) wave corresponding to the wireless communication link;
determining a first spatial position of the sender responsive to the information about the first characteristic of the first RF wave;
adjusting at least one of a level and a timing of an audio signal responsive to the determined first spatial position of the sender; and
providing the adjusted audio signal to at least one audio sink.

2. The method of claim 1, wherein determining the first spatial position of the sender comprises determining one or more of spatial direction and distance.

3. The method of claim 1, wherein the sender is configured to determine the first spatial position of the sender.

4. The method of claim 1, wherein the sender is configured to determine a first spatial position of the receiver.

5. The method of claim 1, wherein the receiver is configured to determine the first spatial position of the sender.

6. The method of claim 1, wherein the first characteristic of the first radio frequency wave corresponding to the wireless communication link is selected from a group consisting of a signal strength, an angle-of-departure, an angle of-arrival, a time of arrival of waves incident individual array elements of an antenna array, and combinations thereof.

7. The method of claim 1, further comprising adjusting at least one of a level and a timing of a second audio signal responsive to a second spatial position of the sender, wherein the second spatial position of the sender is determined responsive to a second characteristic of the first radio frequency wave or another radio frequency wave corresponding to the communication link.

8. The method of claim 7, wherein the first spatial position of the sender and the second spatial position of the sender are different.

9. The method of claim 1, wherein the adjusting the at least one of a level and a timing of the audio signal comprises adjusting the timing and the level of at least one of a first part of the audio signal or a second part of the audio signal, wherein the first part of the audio signal corresponds to a first output channel of the at least one audio sink and the second part of the audio signal corresponds to a second output channel of the at least one audio sink.

10. The method of claim 9, wherein the first output channel and the second output channel are associated with a multichannel output, and the multichannel output comprises two or more channels.

11. The method of claim 9, further comprising:
outputting the first part of the audio signal at a first speaker by way of the first output channel; and
outputting the second part of the audio signal at a second speaker by way of the second output channel.

12. The method of claim 11, wherein the first speaker and the second speaker are incorporated into one or more devices selected from a group consisting of a stereo speakers, headphones, earbuds, hearing aids, bone conduction devices, and combinations thereof.

13. A receiver, comprising:
a transceiver configured to establish at least one wireless communication link;
a controller configured to determine a first spatial position of a sender of one or more wireless communication messages transmitted over the at least one wireless communication link, wherein the first spatial position of the sender is determined responsive to information about a first characteristic of a first radio frequency (RF) wave corresponding to the at least one wireless communication link, wherein the information is included in a communication message of the one or more wireless communication messages transmitted between the sender and the receiver; and
an audio codec comprising decoder circuitry and audio effects circuitry, wherein the audio codec is configured to process audio data into an audio signal by:
decoding the audio data; and
adjust at least one of a timing and a level of an audio signal corresponding to the decoded audio data responsive to the first spatial position of the sender.

14. The receiver of claim 13, wherein the spatial position comprises one or more of spatial direction and distance.

15. The receiver of claim 13, wherein the first characteristic of the first RF wave corresponding to the at least one wireless communication link is selected from a group consisting of a signal strength, an angle of angle-of-departure, an angle of-arrival, triangulation, and combinations thereof.

16. The receiver of claim 13, wherein the audio codec is further configured to adjust at least one of a level and a timing of a second audio signal responsive to a second spatial position of the sender, wherein the second spatial position of the sender is determined responsive to a second characteristic of the first RF wave or another RF wave corresponding to the wireless communication link.

17. The receiver of claim 16, wherein the first spatial position and the sender and the second spatial position of the sender are different.

18. The receiver of claim 17, wherein the audio effects circuitry comprises:
a delay circuitry configured to adjust a timing of at least one of a first part of the audio signal or a second part of the audio signal;
an amplifier circuit configured to adjust a level of at least one of the first part of the audio signal or the second part of the audio signal; and
wherein the first part of the audio signal corresponds to a first output channel of an audio sink and the second part of the audio signal corresponds to a second output channel of the audio sink.

19. A method to output audio received over a wireless communication link, comprising:
establishing a wireless communication link between a sender and a receiver;
receiving communication messages over the wireless communication link, wherein at least some of the communication messages include information about characteristics of one or more radio frequency (RF) waves corresponding to the wireless communication link; and
adjusting a level of an audio signal responsive to a first spatial direction of the sender and/or a distance between the receiver and the sender, wherein the first spatial direction of the sender and/or the distance between the receiver and the sender are determined, at least in part, responsive to the information about the characteristics of the one or more RF waves corresponding to the wireless communication link.

20. The method of claim 19, wherein the first spatial position direction comprises one or more of spatial direction and distance.

21. The method of claim 19, wherein the adjusting the level of the audio signal responsive to the distance between the receiver and the sender comprises increasing the level of the audio signal responsive to an increase in the first spatial direction of the sender.

22. The method of claim 19, wherein the adjusting the level of the audio signal responsive to the distance between the receiver and the sender comprises decreasing the level of the audio signal responsive to an decrease in the first spatial direction and/or the distance between the receiver and the sender.

23. The method of claim 19, wherein the least one of the characteristics of the one or more RF waves corresponding to the wireless communication link comprises one or more of a signal strength, an angle of angle-of-departure, an angle-of-arrival, triangulation and combinations thereof.

24. The method of claim 23, wherein adjusting the level of the audio signal responsive to the distance between the receiver and the sender comprises increasing the level of the audio signal responsive to a decrease in the distance between the receiver and the sender.

25. The method of claim 23, wherein adjusting the level of the audio signal responsive to the distance between the receiver and the sender comprises decreasing the level of the audio signal responsive to an increase in the distance between the receiver and the sender.

26. A receiver, comprising:
a transceiver configured to establish a wireless communication link;
a controller configured to determine a first spatial direction of a sender of communication messages transmitted over the wireless communication link and to determine a distance between the sender and a receiver of the wireless communication messages, wherein the first spatial direction of the sender and the distance between the receiver and the sender are determined, at least in part, responsive to information about characteristics of one or more radio frequency (RF) waves corresponding to the wireless communication link, wherein the information about the characteristics of the one or more RF waves is included in at least some of the communication messages transmitted by the sender; and
an audio controller configured to adjust a timing of an audio signal responsive to the first spatial direction of the sender and/or a level of the audio signal responsive to the distance between the receiver and the sender.

27. A transmitter, comprising:
a transceiver configured to establish at least a first wireless communication link;
a controller configured to:
determine a first spatial position information of a receiver of one or more wireless communication messages over a first wireless communication link, wherein the first spatial position of the receiver is determined responsive to information about a first characteristic of a radio frequency (RF) wave of the first wireless communication link, wherein the information about the first characteristic of the RF wave is included in a communication message received from the receiver; and
transmit the first spatial position over the first wireless communication link.

28. The transmitter of claim 27, further comprising:
audio capture circuitry configured to receive audio signals indicative of audio pressure waves;
an audio codec comprising encoder circuitry and audio effects circuitry, wherein the audio codec is configured to process the audio signals into audio data by:
encoding the audio data responsive to the audio signals; and
adjust at least one of a timing and a level of the audio signals or encoded audio data responsive to a first spatial position of a sender.

29. The transmitter of claim 27, wherein the transceiver is configured to establish a second wireless communication link, and the controller is configured to:
transmit communication messages over the first wireless communication link responsive to a first protocol; and
transmit communication messages of the second wireless communication link responsive to a second protocol, wherein the second protocol is a higher layer protocol than the first protocol.
